(19) United States
(12) Patent Application Publication
(10) Pub. No.: US 2007/0143417 A1
(43) Pub. Date: Jun. 21, 2007

(54) Instant messaging confirmation and receipt

(76) Inventor: Brian K. Daigle, Marietta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/304,341

(22) Filed: Dec. 15, 2005

(51) Int. Cl. G06F 15/16

(52) U.S. Cl. 709/206

(57) ABSTRACT

Included are methods for providing information related to whether an instant messaging recipient received a message. Embodiments of the method include receiving an instant message from an instant messaging sender, wherein the instant message is configured for delivery to an instant messaging recipient and including information related to a read receipt request with the instant message. Embodiments of the method also include sending, to the instant messaging recipient, the instant message with the read receipt request and in response to a determination that the instant messaging recipient has viewed the instant message, receiving a read receipt from the instant messaging recipient, wherein the read receipt includes confirmation that the recipient viewed the sent instant message. Other methods and devices are also provided.

### BACKGROUND

With the advent of the Internet, different forms of digital communications have recently appeared. Examples of such digital communications include email and instant messaging (IM). Often, in instant messaging, a first user communicates with a second user in near real time. Unlike email messages, which reside on a server or a client until deleted, IM messages typically vanish when an IM chat session is terminated, unless that instant messaging chat session is recorded in an instant messaging chat transcript.

Currently, techniques exist in instant messaging (IM) that allows a first instant messaging user to view various actions taken by a second instant messaging user.

More specifically, oftentimes a first user can be provided information related to a second user such as “typing.” While this can provide the first user with information related to whether the second user has received the message, this information is limited to whether the second user is typing or not typing.

While these techniques address various issues in instant messaging, often a first user may be engaged in an instant messaging chat session or otherwise logged onto the instant messaging server. In such a scenario, the first user's client device may send an instant message to a second user that the second user never sees.

Meanwhile, the first user (sender) can waste valuable time waiting for a reply, when in fact, the second user has not yet seen the received a message. In such a scenario, the sender and the instant messaging server will both believe that the message was delivered and incorrectly assume that the recipient has read the message.

Thus, a heretofore unaddressed need exists in the industry to address the aforementioned deficiencies and inadequacies.

### SUMMARY

Included herein are embodiments of a method for providing information related to whether an instant messaging recipient received a message. Some embodiments of the method, among others include receiving an instant message from an instant messaging sender, wherein the instant message is configured for delivery to an instant messaging recipient and including information related to a read receipt request with the instant message. Other embodiments also include sending, to the instant messaging recipient, the instant message with the read receipt request and in response to a determination that the instant messaging recipient has viewed the instant message, receiving a read receipt from the instant messaging recipient, wherein the read receipt includes confirmation that the recipient viewed the sent instant message.

Also included herein are embodiments of a computer readable medium that includes a program for providing information related to whether an instant messaging recipient received a message. Some embodiments of the computer readable medium, among others include logic configured to receive an instant message from an instant messaging sender, wherein the instant message is configured for delivery to an instant messaging recipient and logic configured to include information related to a read receipt request with the instant message. Other embodiments include logic configured to send, to the instant messaging recipient, the instant message with the read receipt request and logic configured to, in response to a determination that the instant messaging recipient has viewed the instant message, receive a read receipt from the instant messaging recipient, wherein the read receipt includes confirmation that the recipient viewed the sent instant message.

Other systems, methods, features, and advantages of this disclosure will be or become apparent to one with skill in the art upon examination of the following drawings and detailed description. It is intended that all such additional systems, methods, features, and advantages be included within this description, be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

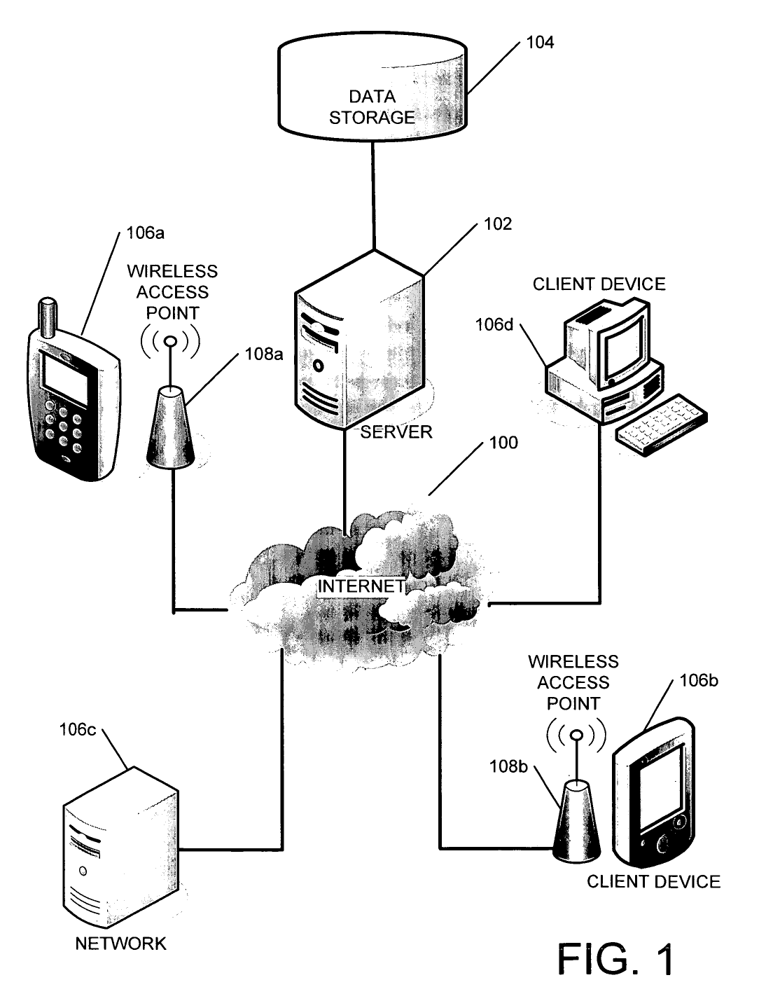

FIG. 1 is a functional diagram of an exemplary instant messaging network environment.

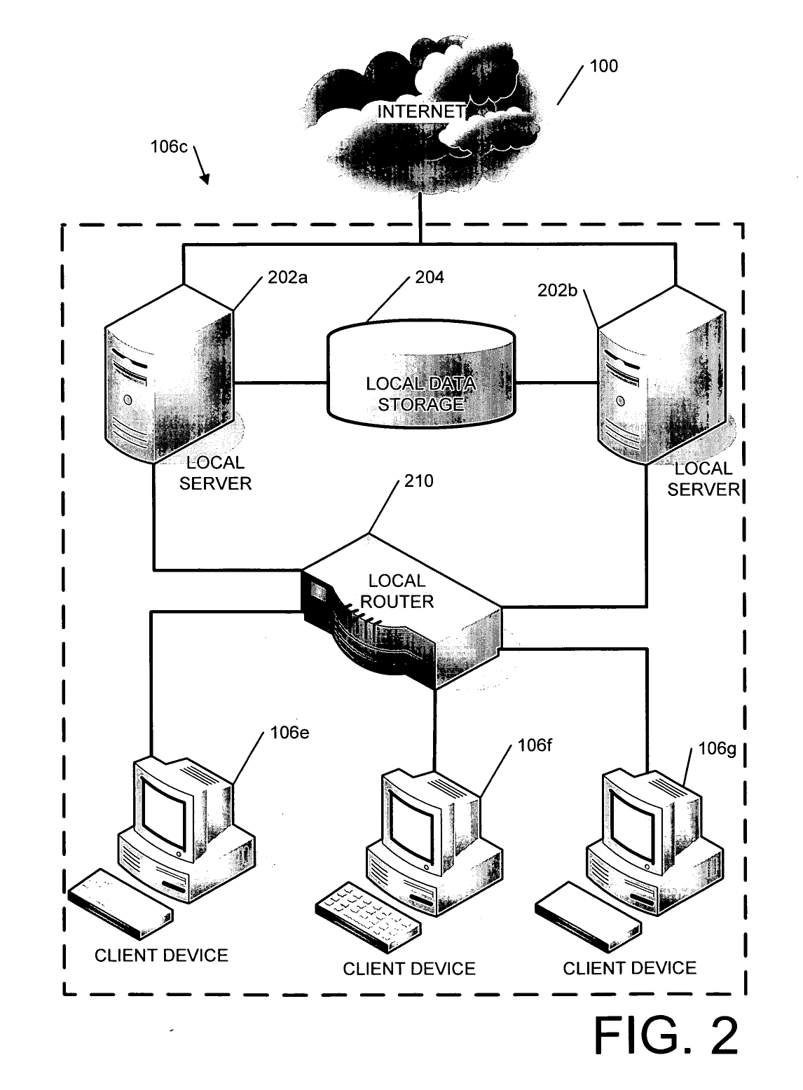

FIG. 2 is a functional diagram of an exemplary local network environment by which a user can send an instant message, similar to the environment from FIG. 1.

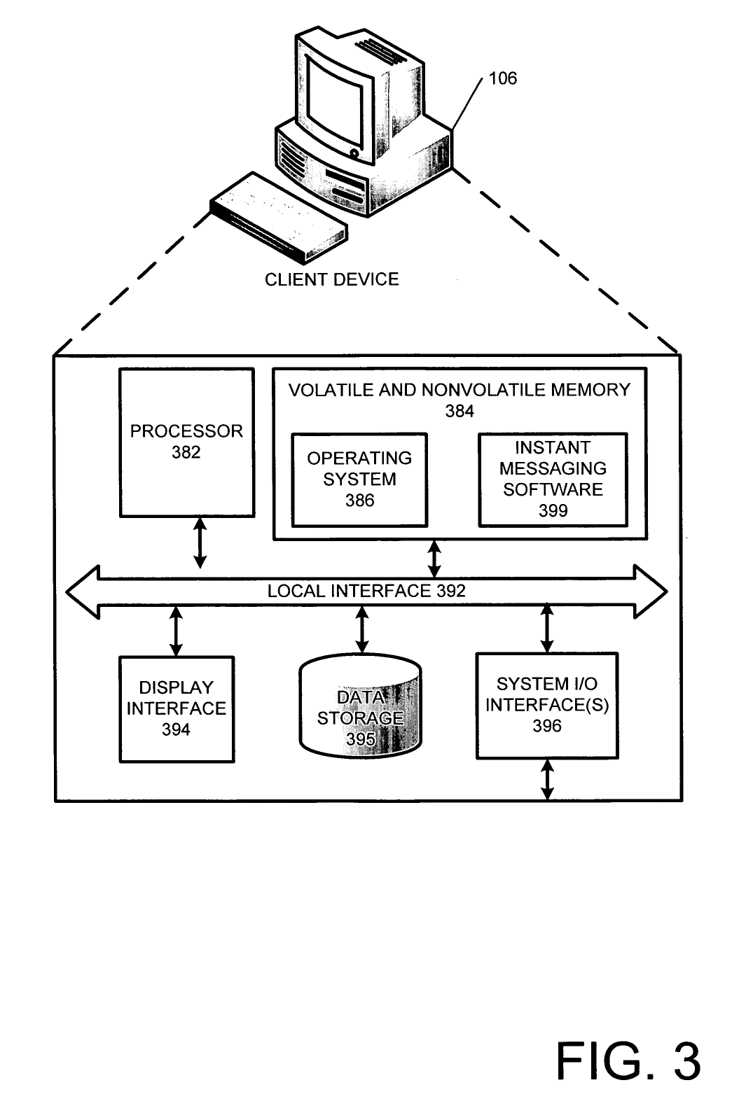

FIG. 3 is a functional diagram illustrating an exemplary embodiment of a client device that may be configured to communicate via a communications network such as the networks from FIGS. 1 and 2.

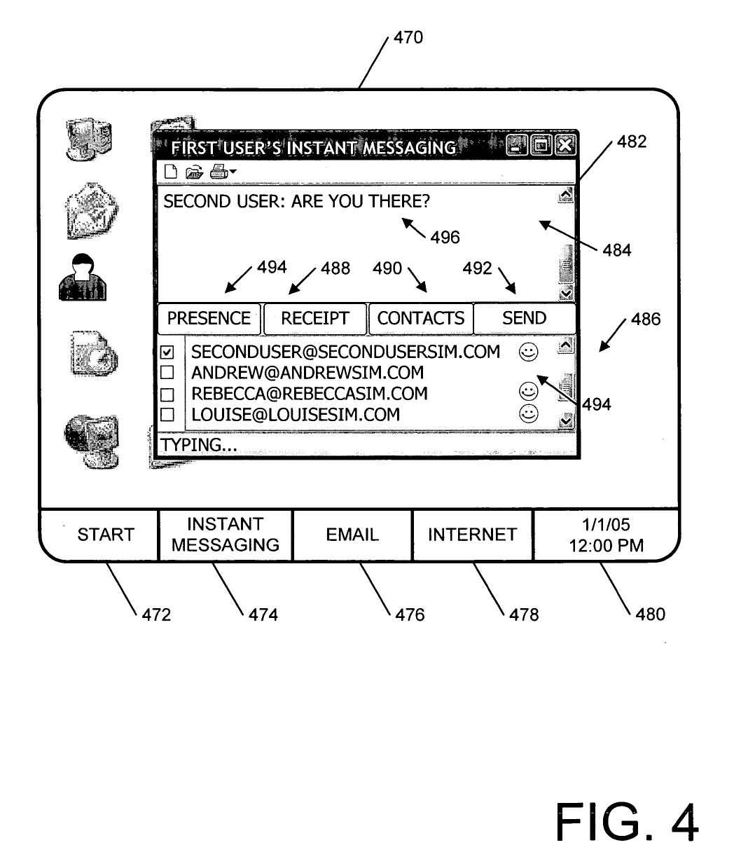

FIG. 4 is an illustration of an exemplary display for the instant messaging client software discussed with reference to FIGS. 1 and 2.

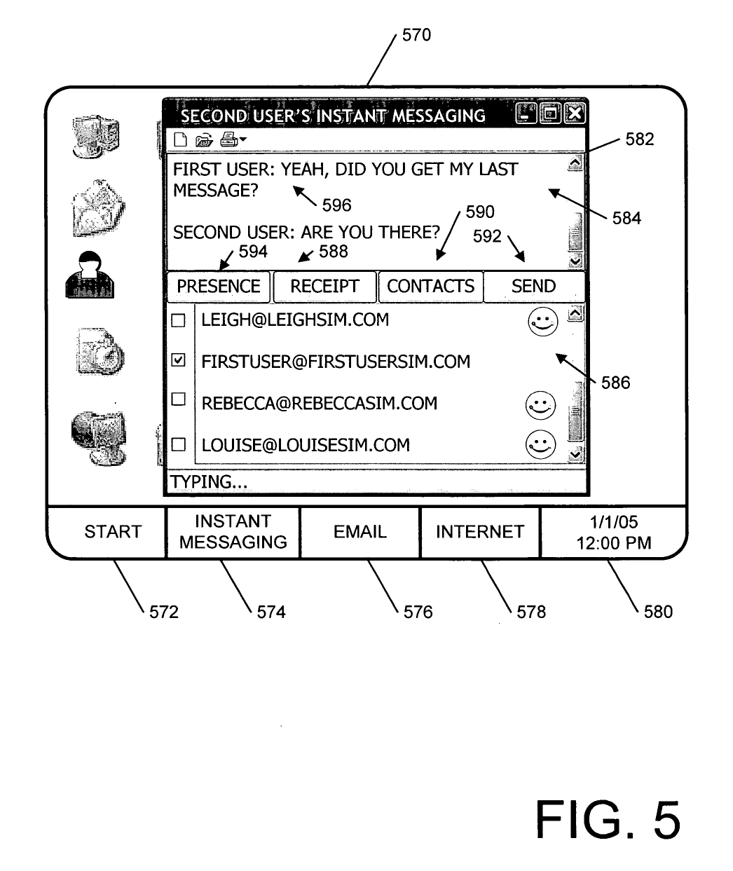

FIG. 5 is an illustration of an exemplary display for the instant messaging client software that has been deselected by the user activating another program, as in an instant messaging environment such as discussed with reference to FIGS. 1 and 2.

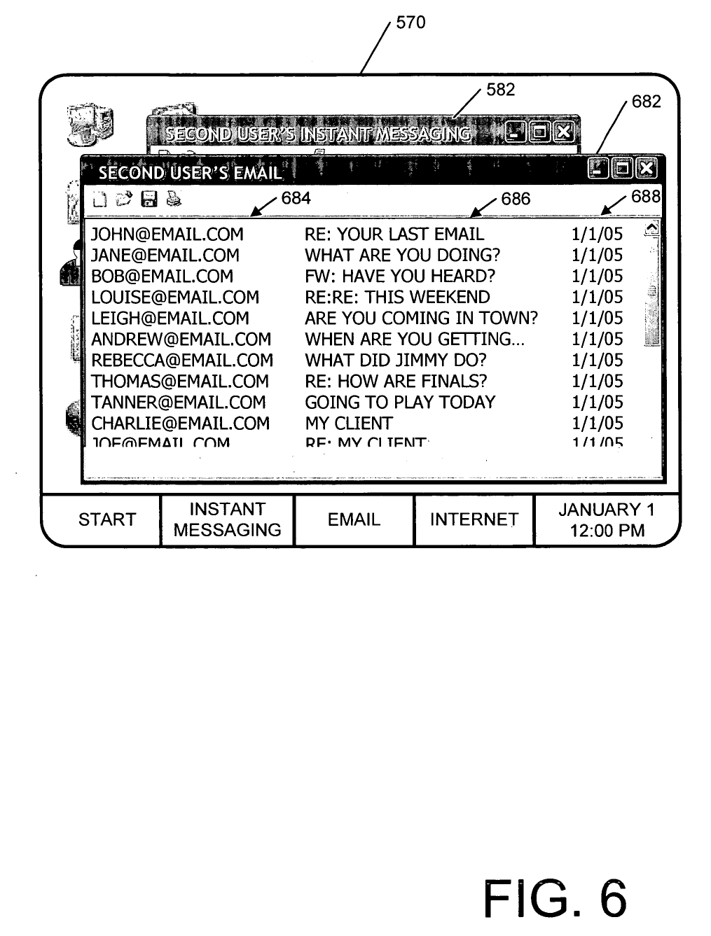

FIG. 6 is an illustration of an exemplary display for a second user's instant messaging client software that has been deselected by the second user activating another program (e.g., window focus is switched to another window), as in an instant messaging environment such as discussed with reference to FIGS. 1 and 2.

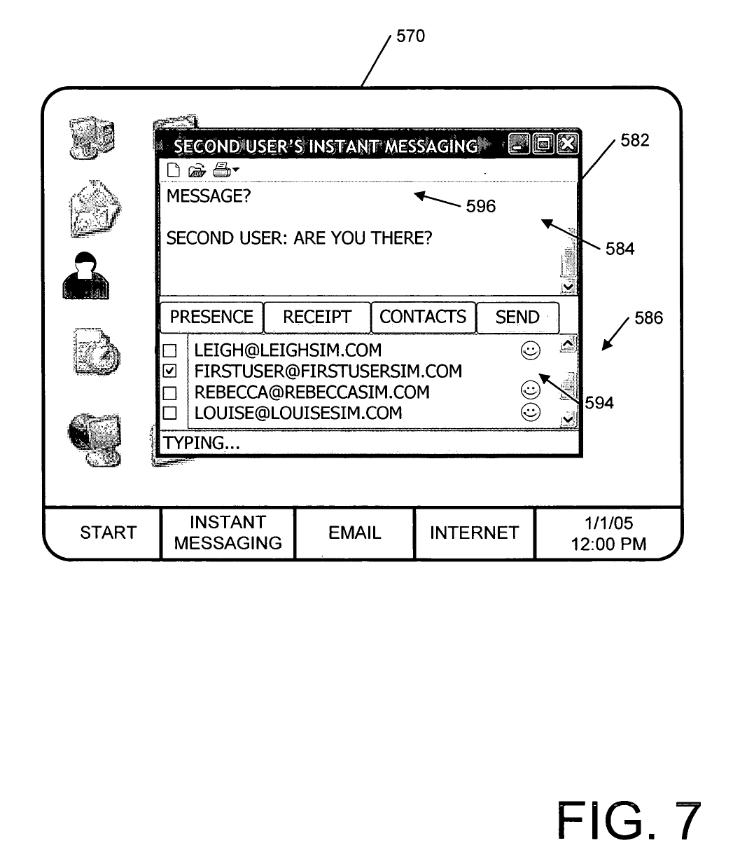

FIG. 7 is an exemplary display for a second user's instant messaging client software that has been scrolled down such as to be unable to view the received instant message as shown in FIG. 5.

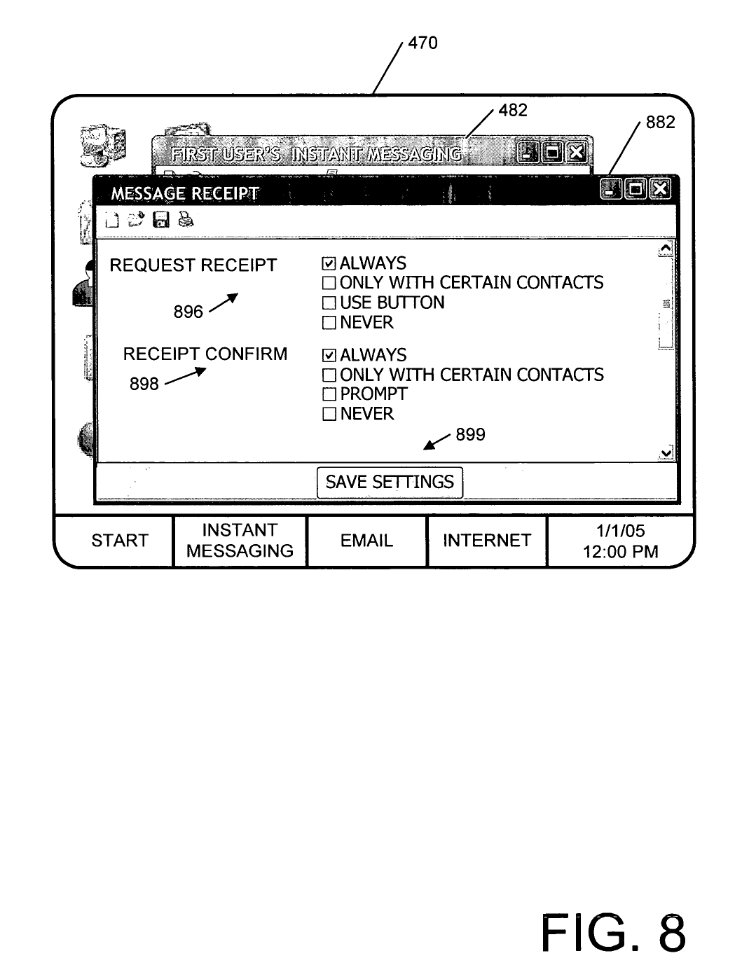

FIG. 8 is an exemplary display of a first user's instant messaging software, illustrating message receipt options that may be provided when accessing the “RECEIPT” option from FIG. 4.

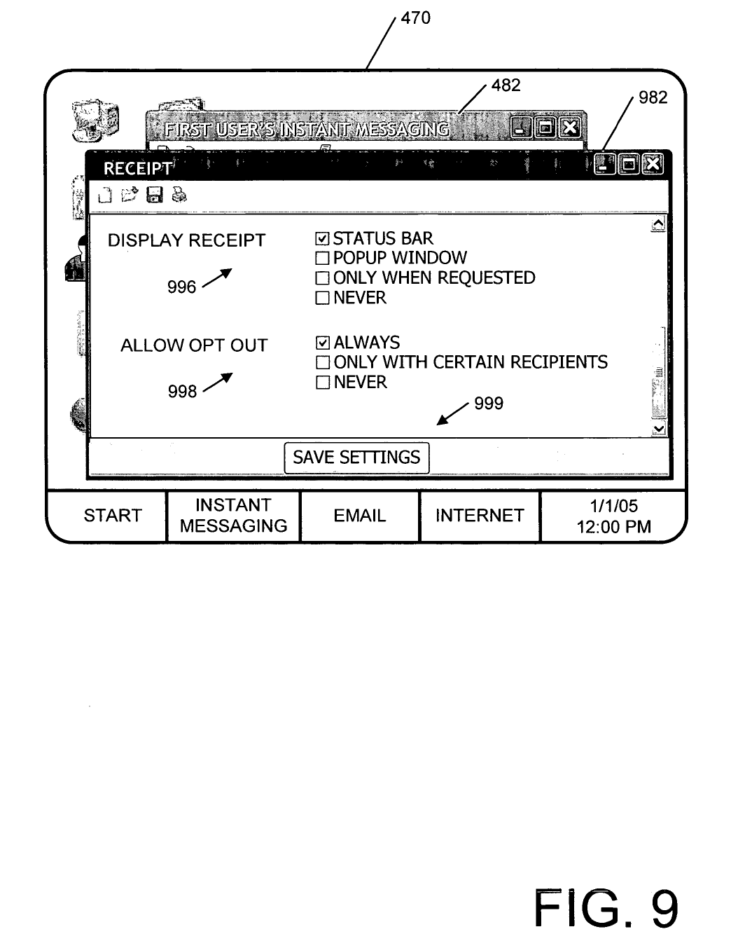

FIG. 9 is an exemplary display of options that can be provided to a first user upon selecting the “RECEIPT” option from FIG. 4.

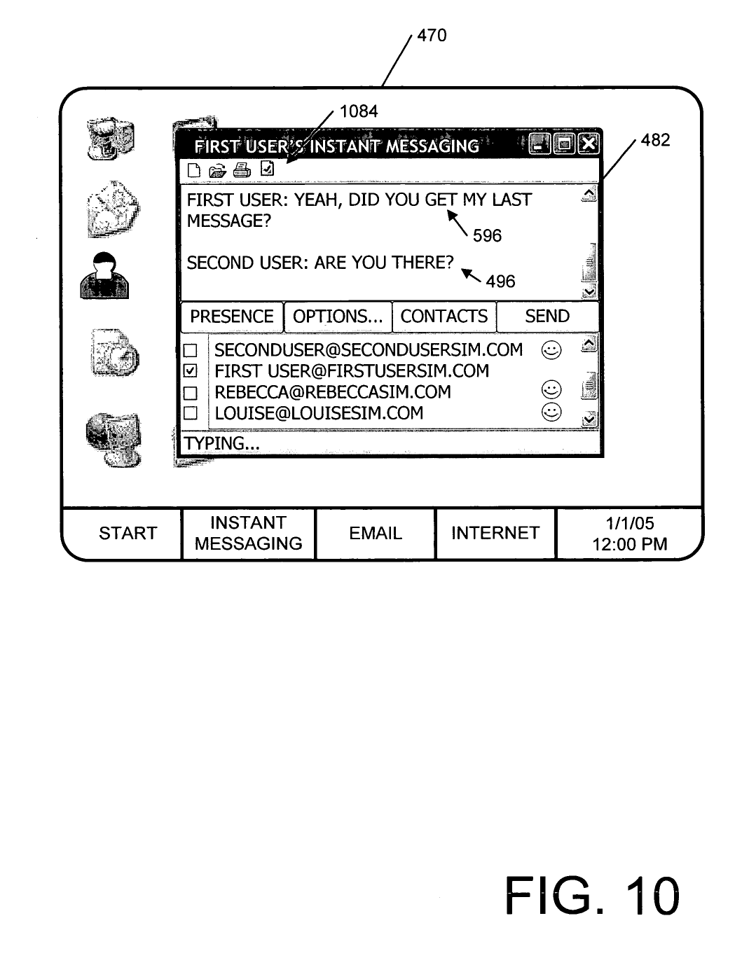

FIG. 10 is an exemplary display for a first user's instant messaging software, with an included read receipt option, discussed with respect to FIG. 4.

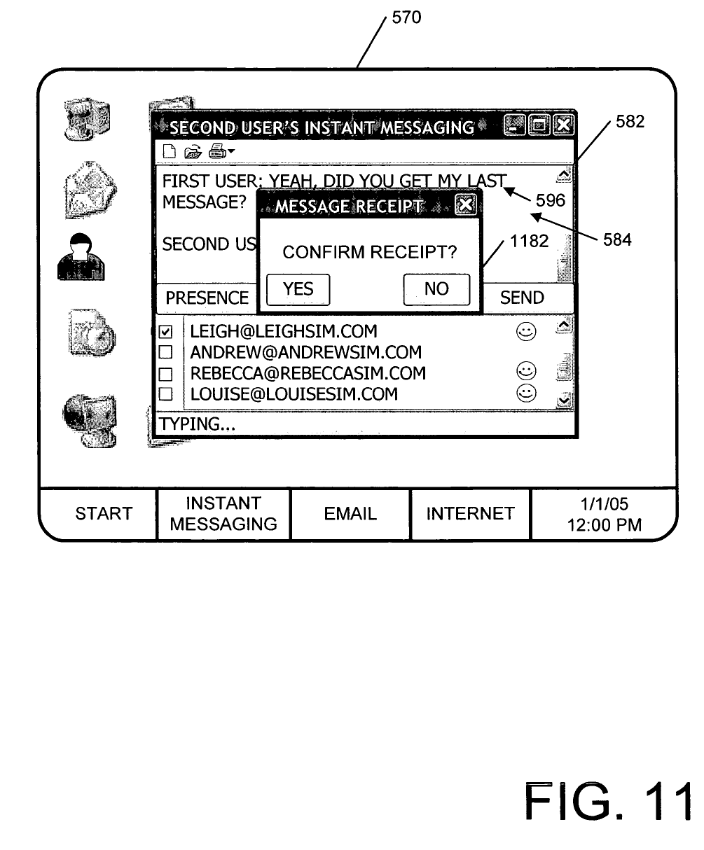

FIG. 11 is an exemplary display of a second user's instant messaging window, illustrating a read receipt window pursuant to the opt out option from FIG. 9.

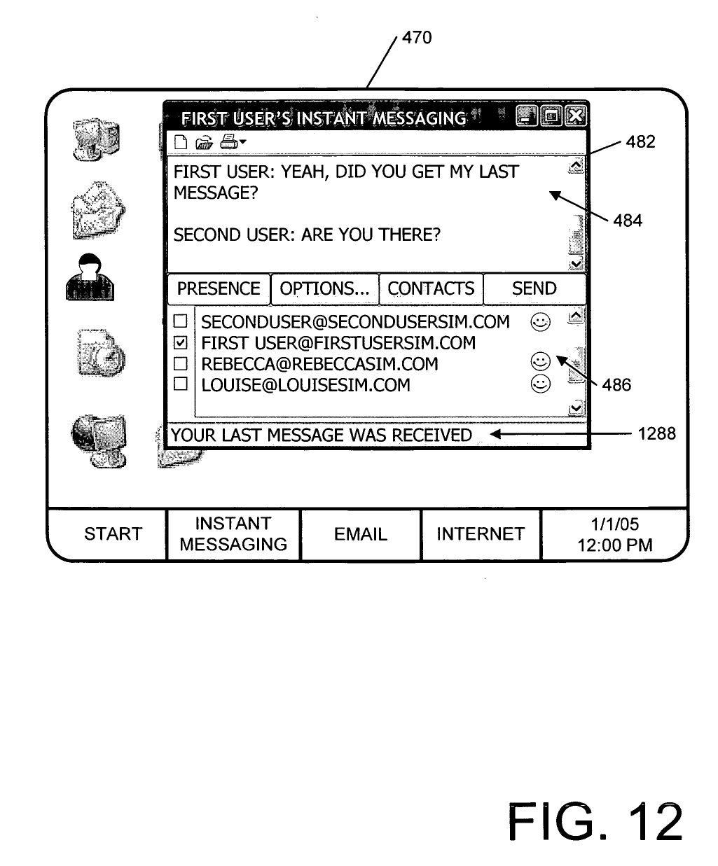

FIG. 12 is an exemplary display of a first user's instant messaging software, with a read receipt confirmation, similar to the display of FIG. 4.

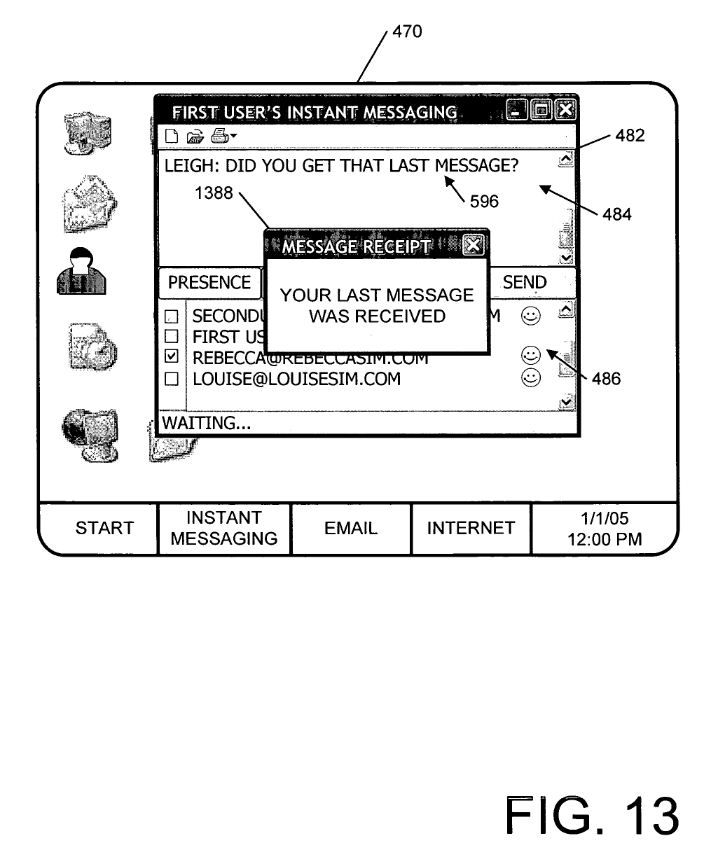

FIG. 13 is an exemplary embodiment of a first user's display illustrating an alternative read receipt confirmation from the display of FIG. 12.

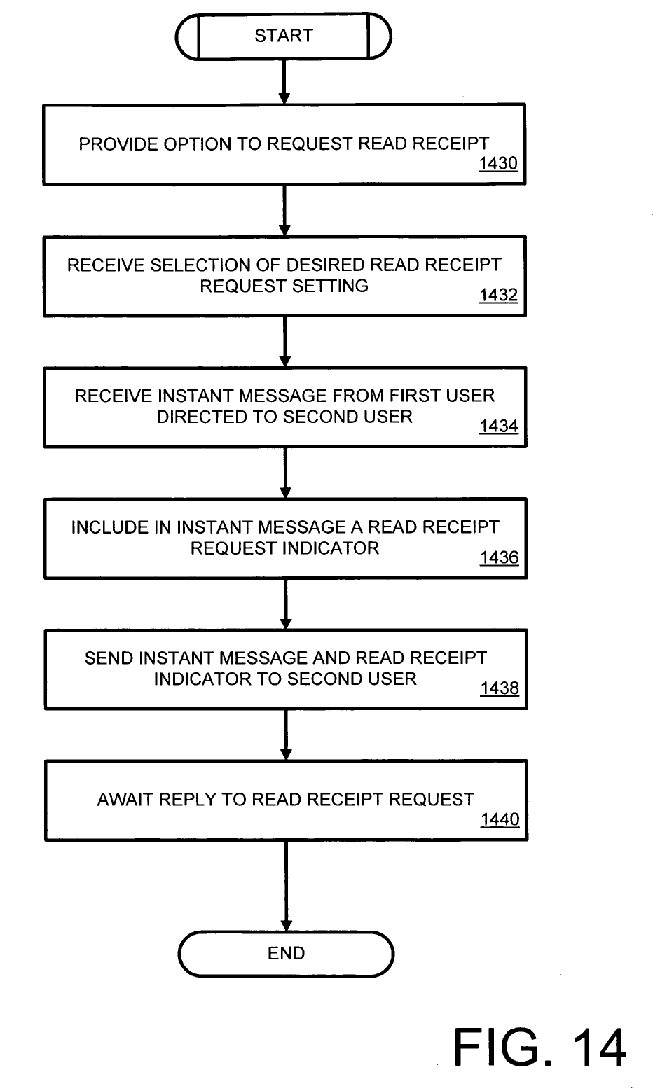

FIG. 14 is a flowchart illustrating exemplary steps that can be taken for creating a read receipt request an instant messaging environment, such as the instant messaging environment illustrated in FIG. 1.

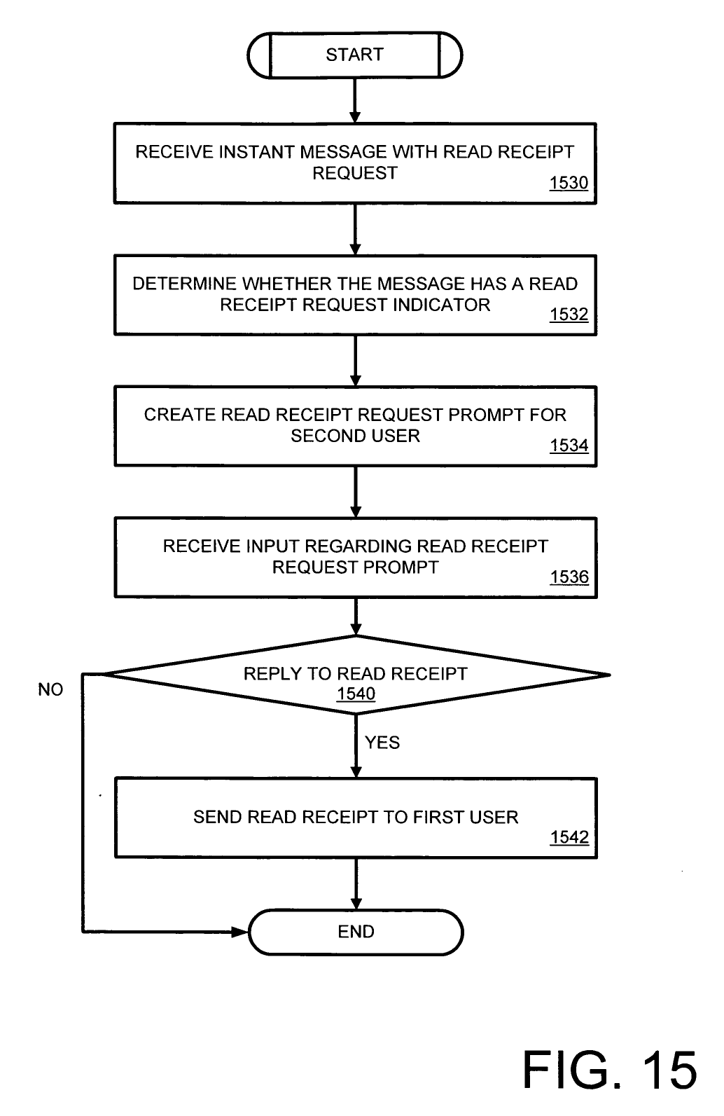

FIG. 15 is a flowchart illustrating exemplary steps that can be taken by a second user's instant messaging software in receiving a read receipt request from a first user in an instant messaging environment, such as the environment from FIG. 1.

### DETAILED DESCRIPTION

FIG. 1 is a functional diagram of an exemplary instant messaging network environment. As illustrated, a plurality of users may be connected via an external network such as Internet 100 or other communications network. The users may access the Internet 100 via client devices 106a (via wireless access point 108a), 106b (via wireless access point 108b), 106c, and 106d. The client devices may include, for example, portable communication devices 106a and 106b, a local network 106c and/or a personal computer 106d. It should be appreciated that the external network, client devices and connections illustrated in FIG. 1 are shown by way of example, but this disclosure is not limited to these examples. The disclosure may be applicable to any client device, connection, and external network that supports instant messaging.

Additionally included in this nonlimiting example is a server 102 that is coupled to a data storage unit 104.

During an instant messaging session, a user may activate instant messaging client software that is stored on the user's client device 106a. Activation of the instant messaging client software can facilitate a connection request with the server 102, which may be a dedicated instant messaging server. The server 102 can then authenticate the user via various authentication techniques including, but not limited to technologies related to a user identification (userid) and password (userpw) and various biometric authentication processes. Generally speaking, the authentication process includes the server receiving the requested data (such as a userid and userpw) and comparing that data with data stored on the data storage device (or data storage logic) 104. If the data submitted by the user matches the data stored in data storage 104, the user can be authenticated.

Once the user has been authenticated, the user can send an instant message to any of his or her contacts (e.g., other users of the instant messaging network).

Generally speaking, the user can send an Instant message to anyone who has an account with the server 102. If the user knows the desired recipient's account name, handle, or instant message identification (IMID) associated with the server 102, the user can send an instant message to that recipient. In many circumstances, the user will have the his or her contacts saved on the instant messaging client software or on the server 102 such that the user does not have to re-enter the account name each time the user wishes to send an instant message.

Additionally, the server 102 can keep track of the various users that are currently logged onto the server, and provide presence information regarding the user's contacts. Thus, if a user wishes to send an instant message to a recipient contact, the server 102 can send information as to whether that contact is currently logged onto the server 102. Upon receiving the presence data related to the user's contacts, the user can then send an instant message to a recipient contact (whose presence is determined), thereby beginning an instant messaging chat session.

In at least one instant messaging environment, each message sent between the user and the contact can be communicated through the server 102. In such a scenario, the user at client device 106a can compose and send an instant message that is directed from the user's client device 106a to the wireless access point 108a, and then to the Internet 100. The message can then be sent to the server 102 back through the Internet 100 to the recipient's client device 106b.

While one or more instant messaging environments may work this way, others may work without the messages being communicated through the server 102. Additionally, some instant messaging environments may have a dedicated instant messaging server (or servers) while others may use devices of varying capabilities to also manage instant messaging traffic. Further, while this nonlimiting example discusses a proprietary instant messaging environment, this disclosure also contemplates an environment utilizing a universal instant messaging protocol, or a communications environment that facilitates communication across a plurality of different instant messaging services using a plurality of different instant messaging protocols.

FIG. 2 is a functional diagram of an exemplary local network environment by which a user can send an instant message, similar to the environment from FIG. 1. The local network environment of FIG. 2 can be a home network, a business network or other network configured to facilitate communication between users. As illustrated, client devices 106e, 106f, 106g are coupled to a local router 210. This coupling may be wire-line or wireless. Though depicted as personal computers, the client devices 106e, 106f, and 106g may be implemented with any device capable of supporting instant messaging in a local network. The local router is coupled to local server 202a and local server 202b. The local servers 202a, 202b (collectively referred to as local server 202) are coupled to local data storage 204. The local servers 202 are also coupled to an external network such as the Internet 100.

In this exemplary networking environment a user located at client device 106e may desire to send an instant message to a recipient located at client device 106g. In the networking environment of FIG. 2, the user at client device 106e can compose and send the instant message via client software stored on the client device 106e. The message can then be sent from the client device 106e to the local router 210. The local router can then send the message to one of the local servers 202. The local server 202 can then communicate the message back through the local router 210 to the intended recipient located at client device 106g.

As the nonlimiting example of FIG. 2 illustrates, instant messages can be sent internal to the local network, without the user of an external network, such as the Internet 100. As stated above, such a configuration may be desirable for a business that wishes to facilitate communication between employees, but not to the Internet community at large. Such a configuration may use its own instant messaging protocol, a universal instant messaging protocol, or a known proprietary instant messaging protocol.

Additionally, while the configuration of FIG. 2 facilitates intra-network instant messaging, such a configuration could also facilitate inter-network instant messaging, similar to the configuration from FIG. 1. In such a scenario, a user operating client device 106f can send messages to and receive messages from a contact that is not located within the local network of FIG. 2 via client device 106f. The message can be sent through local router 210 to local server 202. From local server 202, the message can be sent to an external network, such as the Internet 100.

Referring back to FIG. 1, the message can then be sent from the network 106c to server 102 (which is not part of the local network in FIG. 2), and then back through the Internet 100 to client device 106b. The contact that is operating client device 106b can then reply through the same channels. More specifically, the reply message can be sent from 106b through the Internet 100 to the server 102, back through the Internet 100, to the network 106c (to FIG. 2), to the local server 202, through the local router 210, and back to the user at client device 106f.

One should note that the configuration of FIG. 2 is a nonlimiting example. Components can be added or removed (or both) without diverging from the scope of this disclosure. Additionally, although the configurations from FIGS. 1 and 2 are illustrated as various examples of instant messaging configuration, these are also not meant to be limiting. More specifically, in at least one configuration, instant messages sent between unrelated users need not use the Internet 100. Two users that are engaged in an instant messaging chat session on the same Internet Service Provider (ISP) may not require the use of the Internet 100 to facilitate the communication. As the ISP can link a user to the Internet 100, two users operating on the same ISP may simply use the ISP to facilitate the communication. In such a scenario, the configuration of FIG. 2 becomes more applicable, even for users who are not otherwise related. Additionally, if a company has multiple offices, use of the Internet 100 for instant messaging communications may be desired.

FIG. 3 is a functional diagram illustrating an exemplary embodiment of a client device that may be configured to communicate via a communications network such as the networks from FIGS. 1 and 2. Although a wire-line client device is illustrated, this discussion can be applied to any device. Generally, in terms of hardware architecture, as shown in FIG. 3, the client device 106 includes a processor 382, volatile and nonvolatile memory 384, a display interface 394, data storage 395, and one or more input and/or output (I/O) device interface(s) 396 that are communicatively coupled via a local interface 392. The local interface 392 can include, for example but not limited to, one or more buses or other wired or wireless connections. The local interface 392 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 382 may be a hardware device for executing software, particularly software stored in volatile and nonvolatile memory 384.

The processor 382 can be any custom made or commercially available processor, a central processing unit (CPU), an auxiliary processor among several processors associated with the client device 106, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard® Company, an 80x86 or Pentium® series microprocessor from Intel® Corporation, a PowerPC® microprocessor from IBM®, a Sparc® microprocessor from Sun Microsystems®, Inc, or a 68xxx series microprocessor from Motorola® Corporation.

The volatile and nonvolatile memory 384 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 384 may incorporate electronic, magnetic, optical, and/or other types of storage media. Note that the volatile and nonvolatile memory 384 can have a distributed architecture, where various components are situated remote from one another, but can be accessed by the processor 382. Additionally volatile and nonvolatile memory 384 can also include an operating system 386.

The software in volatile and nonvolatile memory 384 may include one or more separate programs, each of which includes an ordered listing of executable instructions for implementing logical functions. In the example of FIG. 3, the software in the volatile and nonvolatile memory 384 may include instant messaging client software 399, as well as operating system 386. A nonexhaustive list of examples of suitable commercially available operating systems is as follows: (a) a Windows® operating system available from Microsoft® Corporation; (b) a Netware® operating system available from Novell®, Inc.; (c) a Macintosh® operating system available from Apple® Computer, Inc.; (d) a UNIX operating system, which is available for purchase from many vendors, such as the Hewlett-Packard® Company, Sun Microsystems®, Inc., and AT&T® Corporation; (e) a LINUX operating system, which is freeware that is readily available on the Internet 100; (f) a run time Vxworks® operating system from WindRiver® Systems, Inc.; or (g) an appliance-based operating system, such as that implemented in handheld computers or personal data assistants (PDAs) (e.g., PalmOS® available from Palm® Computing, Inc., and Windows CE® available from Microsoft® Corporation). The operating system 386 can be configured to control the execution of other computer programs and provides scheduling, input-output control, file and data management, memory management, and communication control and related services.

A system component embodied as software may also be construed as a source program, executable program (object code), script, or any other entity comprising a set of instructions to be performed. When constructed as a source program, the program is translated via a compiler, assembler, interpreter, or the like, which may or may not be included within the volatile and nonvolatile memory 384, so as to operate properly in connection with the Operating System 386.

The Input/Output devices that may be coupled to system I/O Interface(s) 396 may include input devices, for example but not limited to, a keyboard, mouse, scanner, microphone, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

If the client device 106 is a personal computer, workstation, or the like, the software in the volatile and nonvolatile memory 384 may further include a basic input output system (BIOS) (omitted for simplicity). The BIOS is a set of software routines that initialize and test hardware at startup, start the Operating System, and support the transfer of data among the hardware devices. The BIOS is stored in ROM so that the BIOS can be executed when the client device 106 is activated.

When the client device 106 is in operation, the processor 382 is configured to execute software stored within the volatile and nonvolatile memory 384, to communicate data to and from the volatile and nonvolatile memory 384, and to generally control operations of the client device 106 pursuant to the software.

Software in memory, in whole or in part, are read by the processor 382, perhaps buffered within the processor 382, and then executed.

FIG. 4 is an illustration of an exemplary display for a first user's instant messaging client software discussed with reference to FIG. 3. As illustrated, the desktop display 470 can include a “START” option 472, an “INSTANT MESSAGING” taskbar menu item 474, an “EMAIL” taskbar menu item 476, an “INTERNET” taskbar menu item 478, and a Date and Time indicator 480. As one of ordinary skill in the art will understand, the taskbar menu items can be linked to various software programs that are currently running on the client device 106. As a nonlimiting example, the instant messaging client software 399, which can be configured to display a user interface, similar to instant messaging window 482, relates to the taskbar menu item 474. By selecting the “INSTANT MESSAGING” taskbar menu item 474, the user can display and remove the instant messaging window 482 from the desktop display 470.

As illustrated, the instant messaging window 482 includes an input box 484 for the user to send and receive messages to and from another user. The input box 484 can be configured to display both outgoing messages and incoming messages. As such, a history (thread) of the current instant messaging session can be documented. The input box 484 currently includes an instant message 496 sent by “Second User.” The first user can reply to this message by typing a message in the input box 484 and selecting the “Send” option 492. Additionally, messages can be sent to others by selecting the appropriate checkbox next to the desired contact in the contact section 486 of the instant messaging window 482. Additionally in contact section 486 is a presence icon associated with each contact. As discussed above, the instant messaging server 102 can determine which users are currently logged onto the instant messaging server 102 and can display this information to contacts of that user. In this nonlimiting example, the contacts “Leigh,” “Rebecca,” and “Louise” are currently logged onto the server, while “Andrew” is not logged onto the server.

Additionally included in the instant messaging window 482 are a “PRESENCE” option 494, a “RECEIPT” option 488, a “CONTACTS” option 490, and a “SEND” option 492. The “PRESENCE” option 494 can provide the first user with various options related to the presence of the first user and the first user's contacts. The “RECEIPT” option 488 can provide the first user with access to various options related to the receipt confirmation, as discussed in more detail below. The “CONTACTS” option 490, on the other hand can provide the first user with various options related to the first user's contacts. The “SEND” option 492 is an action button that executes sending of a message to the desired recipient or recipients.

One should note that the instant messaging client software 399 which can be configured to display the user interface of FIG. 4, is included for purposes of illustration, not limitation. As is evident to one of ordinary skill in the art, any instant messaging logic can be used to facilitate communication of instant messages from a user to a contact.

FIG. 5 is an illustration of an exemplary display for a second user's instant messaging client software discussed with reference to FIG. 3. Similar to the configuration of FIG. 4, the desktop display 570 can include a “START” option 572, an “INSTANT MESSAGING” taskbar menu item 574, an “EMAIL” taskbar menu item 576, an “INTERNET” taskbar menu item 578, and a Date and Time indicator 580. By selecting the “INSTANT MESSAGING” taskbar menu item 574, the user can display and remove the instant messaging window 582 from the desktop display 470.

Additionally, the instant messaging window 582 includes an input box 584 for the user to enter a message for other users. Currently, the instant messaging input box 584 includes the instant message 496 composed by the second user and a reply message 596 received from the first user. As described above, messages to other users can be created by selecting the appropriate checkbox, next to the desired user (or users) in the contact section 586 of the instant messaging window 582. Additionally included in contact section 586 is a presence icon associated with each contact.

Also included in the instant messaging window 582 are a “PRESENCE” option 594, a “RECEIPT” option 588, a “CONTACTS” option 590, and a “SEND” option 592. The “PRESENCE” option 594 can provide the first user with various options related to the presence of the first user and the first user's contacts. The “RECEIPT” option 588 can provide the second user with access to various options related to receipt confirmation, as discussed in more detail below. The “CONTACTS” option 590, on the other hand, can provide the second user with various options related to the second user's contacts. The “SEND” option 592 is an action button that executes sending of a message to the desired recipient or recipients.

One should note that the interface for the instant messaging client software 399 displayed in FIG. 5 is included for purposes of illustration, not limitation. As is evident to one of ordinary skill in the art, any instant messaging logic can be used to facilitate communication of instant messages from a user to a contact.

FIG. 6 is an illustration of an exemplary display for a second user's instant messaging client software that has been deselected by the second user activating another program (e.g., window focus is switched to another window), as in an instant messaging environment such as discussed with reference to FIGS. 1 and 2. As illustrated, the desktop display 570 includes the “START” option and Date and Time indicator. Also included are the “INSTANT MESSAGING,” “EMAIL,” and “INTERNET” menu taskbar items. As discussed with reference to FIG. 5, the “INSTANT MESSAGING” taskbar menu item 574 is associated with the instant messaging window 582. Similarly, the “EMAIL” taskbar menu item is associated with the Email window. The Email window 682 includes a list of received emails from other users, as shown in column 684. A description of the received email is denoted in column 686 and the date the email was received is denoted in column 688.

As shown in FIG. 6, the Email window 682 has covered up the instant messaging window 582. As such, when the second user receives an instant message from a sender (such as the first user), the second user may not be aware of the arrival of the Instant Message (such as instant message 596). Additionally, as many operating systems 386 provide a signal indicating that a change in a de-selected window has occurred (such as receiving an instant message when the instant messaging window is de-selected), the second user may be aware of the message, but for whatever reason has not read the received message. As a nonlimiting example, the second user may be busy on another program, or may not be at the client device 106 when the message is received. Regardless of the reason, the second user's client device 106 receiving a message does not necessarily mean that the second user receives the message. As such, the sender of the instant message (in this case, the first user) may be awaiting a reply message, unaware that the second user has not yet viewed the received instant message 596.

FIG. 7 is an exemplary display for a second user's instant messaging client software has scrolled down such as to be unable to view the received instant message as shown in FIG. 5. More specifically, even though the second user's instant messaging window is active, the user may not see the instant message 596 received from the first user. In the nonlimiting example of FIG. 7, the second user is not able to view the received instant message 596 because the second user has scrolled the input prompt 584 down such that the received message 596 is not visible. As such, the recipient (second user) of the instant message may be unaware of arrival of the instant message, or otherwise may not have read the received instant message.

One should note that FIGS. 6 and 7 illustrate situations where the second user's instant messaging software 399 receives a message, but the second user does not “view” the message at the time the message is received, perhaps because the user may be unaware that the message has arrived. While the discussion with regard to these drawings are illustrative of possible scenarios where this can occur, these are not the only situations were a user does not view an instant message. Other nonlimiting examples can include situations where the second user is no longer physically located at client device 106, situations where the second user's screen saver has been activated, and situations where the second user has disconnected from the instant messaging server 102. Other situations can also result in the second user not viewing the message.

FIG. 8 is an exemplary display of a first user's instant messaging software, illustrating message receipt options that may be provided when accessing the “RECEIPT” option from FIG. 4. More specifically, upon accessing the “RECEIPT” option from FIG. 4, the first user can be provided with message receipt options window 882, which can provide various options with regard to receipt requests for the instant messaging software 399. As illustrated in the message receipt window 882, the first user can select an option relating to the request receipt option 896. From this option, the first user can determine whether, upon sending outgoing instant messages, a receipt request is also included in the sent message. The first user can determine whether a receipt request is always sent, sent only with certain contacts, sent only when a receipt button is selected (more detail below), or never sent. An additional option provided in FIG. 8 is a receipt confirm option 898, which determines how the first user's instant messaging software 399 responds to receiving a receipt request from another user. Options include to always providing a receipt confirmation, providing a receipt confirmation only with certain contacts, prompting the first user to confirm receipt of an instant message (or group of messages) preferably before the user views the message(s), and never responding to receipt requests. The save settings option 899 can save the selected options.

FIG. 9 is an exemplary display of options that can be provided to a first user upon selecting the “RECEIPT” option from FIG. 4. More specifically, included in receipt display 982 is a display receipt option 996. The display receipt option 996 can include an option to display information related to a received reply to a receipt request in the status bar, to display the reply in a popup window, to display the reply only when requested by the first user, and to never display the reply. Additionally included is an “allow opt out” option 998. The “allow opt out” option 998 can provide a recipient of a read receipt request the ability to opt out of replying to the read receipt. The available options are to always allow recipients to opt out, to only allow certain recipients to opt out, or to never allow a recipient to opt out. The save settings option 999 can save the selected options.

FIG. 10 is an exemplary display for a first user's instant messaging software, with an included read receipt option, discussed with respect to FIG. 4. More specifically, before sending the composed message 596, the first user can select the read receipt option 1084 to require that the recipient of the message (second user) provide a read receipt upon reading the instant message. The read receipt can take the form of the second user's instant messaging software 399 automatically providing a read receipt upon activation of the instant messaging window 582 after receiving the instant message, automatically providing a read receipt upon the message being visible in the instant messaging window 582, the second user providing an input related to viewing the instant message, or other forms of determining whether the message has been viewed by the recipient (second user).

Depending on the configuration, the read receipt option 1084 may or may not be present in instant messaging window 482. While some embodiments may implement the read receipt option with the options from FIGS. 8 and 9, this is not a requirement. Additionally, the read receipt option 1084 can be utilized to indicate the option from the receipt request option 896 that has been selected. More specifically, if the first user has selected the “always” option from “request receipt” option 896 the read receipt option 1084 can be set such that the checkbox associated with read receipt option 1084 is always checked or “grayed out” with no option for the first user to deselect the option, except via the “receipt” option 488 (FIG. 4).

FIG. 11 is an exemplary display of a second user's instant messaging window, illustrating a read receipt window pursuant to the opt out option from FIG. 9. More specifically, the first user can provide recipients of the read receipt with the option to opt out of providing a reply to the read receipt. By the sender (first user) selecting one of the options in the opt out option 998, a recipient (second user) can be provided with message receipt display 1182 in addition to the instant message 596 displayed in input prompt 584. Upon receiving the instant message 596 and the message receipt 1182, the second user can select whether he or she wishes to confirm receipt of the message, or group of message that have yet to be viewed. If the second user selects the “Yes” option, the first user (sender) will be provided with a read confirmation. If the second user selects the “No” option (or otherwise indicates nonconfirmation of the read receipt request), the first user will not be provided with a read confirmation. After the user selects whether to confirm read/receipt, the user may be presented with any unviewed messages.

Other embodiments can provide for the first user to select an option that prevents the second user from viewing any messages without confirming that the message(s) has been read or received. Once the second user's instant messaging client software 399 receives a message and determines that the first user designated the message(s) as requiring read/receipt confirmation, the client software 399 may prompt the second user to select whether he or she wishes to confirm receipt of the message or group of messages that have yet to be viewed. With this feature, if the second user selects the “No” option (i.e., indicating that a read receipt is not provided to the first user), the first user will not be provided with a read confirmation. However, in this nonlimiting example, in response to selecting the “No” option, the second user can also be precluded from viewing the received message.

FIG. 12 is an exemplary display of a first user's instant messaging software, with a read receipt confirmation, similar to the display of FIG. 4. More specifically, the first user can receive a read receipt 1288 that is displayed in the status bar at the bottom of the instant messaging window 482. Referring back to FIG. 9, the first user can determine the method of delivering the read receipt. One should note that while the first user has determined that read receipts are displayed in the status bar, this is but a nonlimiting example. Other display configurations are also contemplated in this disclosure.

FIG. 13 is an exemplary embodiment of a first user's display illustrating an alternative read receipt confirmation from the display of FIG. 12. More specifically, instant messaging display 482 can facilitate display of the message receipt popup window 1388 indicating that the message 596 was received. Depending on the first user's desires, the instant messaging display 482 can provide this or any other configuration for indicating that a sent message has been read. Similarly, the first user can turn off the read receipt option or simply disable display of the confirmation receipt.

As another nonlimiting example, the color or shade of the text of any confirmed or nonconfirmed messages may differ. Other embodiments can provide that the first user (sender's) instant messaging window 482 can display an icon, letter, or other signifier (such as “N” or “C”) next to messages to indicate whether the message has been confirmed or not confirmed.

FIG. 14 is a flowchart illustrating exemplary steps that can be taken for creating a read receipt request an instant messaging environment, such as the instant messaging environment illustrated in FIG. 1. The first step in this nonlimiting example is to provide an option to request a read receipt for an instant message (block 1430). The option can be provided by the first user's instant messaging software 399, and can be provided with each outgoing message, can be provided as an overall setting for all messages, or can be provided based on the recipient. Next, the first user's instant messaging software can receive (block 1432) selection of a desired receipt request setting. Similar to the configurations from FIGS. 8 and 9, the first user can also determine how he or she desires the read receipt function to operate, as well as determine other instant messaging options.

Next, the first user's instant messaging software can receive an instant message from the first user directed to a second user (block 1434). This can include receiving textual input in input prompt 482 (FIG. 4) or other form of inputting an instant message. Next, the first user's instant messaging software 399 can include in the received instant message, a receipt request indicator (block 1436). The read request indicator can take the form of a bit or bit stream (or other indicating data) that can communicate, to the recipient's (second user's) instant messaging software 399, that a read receipt has been requested. The indicator can further indicate various options that have been selected for the read receipt by the first user, however, this is a nonlimiting example.

The next step in the flowchart of FIG. 14 is for the first user's instant messaging software to send the instant message and receipt request indicator to the second user (block 1438). The first user's instant messaging software can then await a reply to the receipt request (block 1440).

Additionally, other embodiments can include a feature that allows the first user to prevent the second user from viewing a message (or multiple messages) unless the second user confirms the read receipt option provided with the message. As a nonlimiting example, the first user's client software 399 can provide an option for denying full delivery of a message to a recipient who does not confirm receipt of a message. In such a scenario, the second user (recipient) can be provided with an indication that a message is received, but the message can be withheld from display until the second user confirms receipt of the message. Additionally, the second user's client software 399 can provide the second user with options that relate to always providing read receipt of received messages, never providing read receipt, prompting or the second user for read receipt. Additionally, these options can apply to all received messages, to messages received from certain senders, to the current messaging thread, etc.

One should note that while the steps described with respect to FIG. 14 are directed to the first user's instant messaging software, one or more of these steps could also be performed by a server, such as instant messaging server 102. Similarly, while the description above discusses instant messaging between two users, the principles discussed can be expanded to include instant messaging between more than two users.

FIG. 15 is a flowchart illustrating exemplary steps that can be taken by a second user's instant messaging software in receiving a read receipt request from a first user in an instant messaging environment, such as the environment from FIG. 1. More specifically, the first step in the flowchart of FIG. 15 is for the second user's instant messaging software 399 to receive an instant message with a read receipt request (block 1530). Next, the second user's instant messaging software 399 can determine whether the received instant message includes a read receipt request indicator (block 1532). If the received instant message includes a read receipt request indicator, the second user's instant messaging software 399 can create a receipt request prompt for the second user (block 1534). More specifically, the second user's instant messaging software 399 can prompt the second user as to whether the second user wishes to reply to the read receipt request (see FIG. 11). Next, the second user's instant messaging software 399 receives input regarding the receipt request prompt (block 1536). Upon receiving the input, the second user's instant messaging software 399 can determine whether, based on the received input regarding the request prompt, the second user replied to the read receipt request (block 1540). If the second user does not wish to reply to the read receipt request, the flowchart ends. If, on the other hand, the second user does reply to the read receipt request, the second user's instant messaging software can send the read receipt to the first user (block 1542).

While the description of FIG. 15 describes a scenario where the second user can determine whether to reply to the read receipt request, this is but a nonlimiting example. More specially, depending on the configuration, the first user's settings, and the second user's settings, the read receipt may be automatically sent from the second user's instant messaging software 399 to the first user's instant messaging software 399 upon a determination that the second user has viewed the received instant message. More specifically embodiments can include determining whether the second user's instant messaging window 582 is in focus. Other embodiments can include logic that will send the read receipt in response to a determination that the second user's instant messaging window 582 is in focus for a predetermined time period. As a nonlimiting example, if the second user's instant messaging window 582 is in focus (or active) for five seconds, a determination can be made that the second user has viewed the message. A read receipt can then be sent.

Additional embodiments of the methods described herein can allow the first user to prevent the second user from viewing messages unless the second user provides a read receipt confirmation. As discussed above, at least one nonlimiting example can include determining whether a message sent by the first user requires a read receipt confirmation prior to providing the second user with the message. If the second user (recipient) does not confirm receipt of the message, the second user can be precluded from receiving the message. One should also note that depending on the particular configuration, this option can be exercised by the first user's client software 399, the second user's client software 399, the server 102, or any permutation of these or other elements.

Other embodiments can also include a determination of whether the second user is physically present at the client device. More specifically, motion detection, audio detection, other bio-sensory devices, etc. can be used to make this determination. Additionally, other embodiments can provide that the second user opts out of providing a read receipt without the permission of the first user.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for providing information related to whether an instant messaging recipient received a message, the method comprising:
receiving an instant message from an instant messaging sender, wherein the instant message is configured for delivery to an instant messaging recipient;
including information related to a read receipt request with the instant message;
sending, to the instant messaging recipient, the instant message with the read receipt request; and
receiving a read receipt from the instant messaging recipient, wherein the read receipt includes confirmation that the recipient viewed the sent instant message.

2. The method of claim 1, further comprising displaying information related to the read receipt.

3. The method of claim 2, wherein displaying information related to the read receipt includes at least one of the following: displaying the information in a popup, displaying the information in a status bar, and displaying the information with at least one indicator associated with the instant message.

4. The method of claim 1, further comprising providing an option for the instant messaging recipient to opt out of providing the read receipt.

5. The method of claim 1, further comprising providing an option to the instant messaging sender to include a read receipt request with all outgoing instant messages.

6. The method of claim 1, further comprising providing an option to the instant messaging sender to determine which outgoing instant messages include a read receipt request.

7. The method of claim 1, wherein the determination of whether the instant messaging recipient has viewed the instant message includes at least one of the following: determining whether an instant messaging software associated with the instant messaging recipient is in focus, determining whether the instant messaging recipient is physically present at a client device to which the instant message is delivered, and determining whether the instant message is viewable on a client device associated with the instant messaging recipient.

8. The method of claim 1, further comprising withholding communication of the instant message in response to receiving a read receipt nonconfirmation from the second user.

9. A computer readable medium that includes a program for providing information related to whether an instant messaging recipient received a message, the program comprising:
logic configured to receive an instant message from an instant messaging sender, wherein the instant message is configured for delivery to an instant messaging recipient;
logic configured to include information related to a read receipt request with the instant message;
logic configured to send, to the instant messaging recipient, the instant message with the read receipt request; and
logic configured to receive a read receipt from the instant messaging recipient, wherein the read receipt includes confirmation that the recipient viewed the sent instant message.

10. The computer readable medium of claim 9, the program further comprising logic configured to display information related to the read receipt.

11. The computer readable medium of claim 10, wherein displaying information related to the read receipt includes at least one of the following: displaying the information in a popup, displaying the information in a status bar, and displaying the information with at least one indicator associated with the instant message.

12. The computer readable medium of claim 9, the program further comprising logic configured to provide an option for the instant messaging recipient to opt out of providing the read receipt.

13. The computer readable medium of claim 9, the program further comprising logic configured to provide an option to the instant messaging sender to determine which outgoing instant messages include a read receipt request.

14. The computer readable medium of claim 9, wherein the determination of whether the instant messaging recipient has viewed the instant message includes at least one of the following: determining whether an instant messaging software associated with the instant messaging recipient is in focus, determining whether the instant messaging recipient is physically present at a client device to which the instant message is delivered, and determining whether the instant message is viewable on a client device associated with the instant messaging recipient.

15. A method for providing information related to whether an instant message is viewed by an instant messaging recipient, the method comprising:
receiving an instant message from an instant messaging sender, wherein the instant message includes a read receipt request;
determining whether the received instant message includes information related to a read receipt request;
in response to determining that the received instant message includes information related to a read receipt request; determining whether the instant messaging recipient has viewed the received instant message; and
in response to determining that the instant messaging recipient has viewed the received instant message, sending a read receipt to the instant messaging sender.

16. The method of claim 15, further comprising providing an option to the instant messaging recipient to reply to the received read receipt request.

17. The method of claim 15, wherein determining whether the instant messaging recipient has viewed the received instant message includes at least one of the following: determining whether an instant messaging software associated with the instant messaging recipient is in focus, determining whether the instant messaging recipient is physically present at a client device to which the instant message is delivered, and determining whether the instant message is viewable on a client device associated with the instant messaging recipient.

18. The method of claim 15, further comprising receiving input from the instant messaging recipient, wherein the input indicates whether to respond to the received read receipt request.

19. The method of claim 15, further comprising sending a reply instant message from the instant messaging recipient to the instant messaging sender, wherein the reply message includes a read receipt corresponding to the received instant message.

20. The method of claim 15, further comprising displaying information related to the received read receipt request.
